(19) United States
(12) Patent Application Publication
(10) Pub. No.: US 2005/0133572 A1
(43) Pub. Date: Jun. 23, 2005

(54) Methods of forming solder areas on electronic components and electronic components having solder areas

(75) Inventors: Nathaniel E. Brese, Farmingdale, NY (US); Michael P. Toben, Smithtown, NY (US)

Correspondence Address: EDWARDS & ANGELL, LLP, P.O. BOX 55874, BOSTON, MA, 02205, US

(73) Assignee: Rohm and Haas Electronic Materials LLC

(21) Appl. No.: 11/022,235

(22) Filed: Dec. 22, 2004

Related U.S. Application Data
(60) Provisional application No. 60/532,264, filed on Dec. 22, 2003.

(51) Int. Cl. B23K 31/02

(52) U.S. Cl. 228/180.22; 228/248.1

(57) ABSTRACT

Disclosed are methods of forming solder areas on electronic components. The methods involve: (a) providing a substrate having one or more contact pads; and (b) applying a solder paste over the contact pads. The solder paste includes a carrier vehicle and a metal component having metal particles. The solder paste has a solidus temperature lower than the solidus temperature that would result after melting of the solder paste and resolidification of the melt. Also provided are electronic components which can be formed by the inventive methods. Particular applicability can be found in the semiconductor industry in the formation of interconnect bumps on a semiconductor component, for example, for bonding an integrated circuit to a module circuit or printed wiring board using a bump bonding process.

### CROSS-REFERENCE TO RELATED APPLICATIONS

This application claims the benefit under 35 U.S.C. § 119(e) of U.S. Provisional Application No. 60/532,264, filed Dec. 22, 2003, the entire contents of which are incorporated herein by reference.

### BACKGROUND OF THE INVENTION

This invention relates to methods of forming solder areas on electronic components. As well, the invention relates to electronic components having solder areas. Particular applicability can be found in the semiconductor industry in the formation of interconnect bumps on a semiconductor device, for example, for bonding an integrated circuit (IC) to a module circuit, an interposer, or a printed wiring board (PWB) using a solder bump bonding process.

There is a current focus in the semiconductor manufacturing industry on wafer-level-packaging (WLP). In wafer-level-packaging, IC interconnects are fabricated en masse on a wafer, and complete IC modules can be built on the wafer before it is diced. Benefits gained using WLP include, for example, increased input/output (I/O) density, improved operating speeds, enhanced power density and thermal management, decreased package size, and improved manufacturing cost efficiencies.

In WLP, conductive interconnect bumps can be provided on the wafer. For example, the original C4 (“controlled collapse chip connection”) process employs solder bumps deposited on flat contact pad areas of the IC chips for bonding one or more of the chips to a module circuit. The solder bumps on the chips are matched with corresponding contact pads on the module circuit. The chip and module circuit are brought into contact with each other and heated to melt the solder. These interconnect bumps serve as electrical and physical connections between the IC chip and module circuit. The module circuit is typically then attached to a PWB by applying solder to other contact pads on the module circuit, bringing the module circuit into contact with contact pads on the PWB and heating the structure to reflow the solder. Alternatively, wire bonding may be used in place of solder to make certain interconnections as well.

Several methods of forming interconnect bumps on semiconductor devices have been proposed, such as electroplate bumping, evaporation bumping, and bump printing. Of these techniques, electroplate bumping and evaporation bumping generally require a significant capital investment for the processing equipment. Bump printing, on the other hand, is a less capital-intensive process. In bump printing, a patterned metal mask is placed or formed over a substrate. The mask has openings corresponding to the contact pads on which the bumps are to be formed. The openings in the mask are filled with a solder paste by first applying the solder paste over the mask and then using a tool such as a squeegee to push the solder paste into the openings. The mask is removed and the solder paste is heated, thus forming metal solder bumps from the solder paste.

The metal solder bumps should be capable of making reliable and consistent electrical connection between the bonding pad of the semiconductor component and the module circuit. The solder pastes used in bump printing are typically a combination of metal particulates and a carrier vehicle, which may include, for example, a solvent, an organic fluxing agent, and an activator. A number of limitations are associated with conventional solder pastes. For example, residues from the carrier vehicle components often remain in the solder bumps after heat treatment. Such residues may adversely affect the physical and/or electrical properties of the contact. In order to minimize or prevent such residues, excessively high temperatures not compatible with the device or substrate materials may be required.

The solder materials used in the C4 or other wafer bumping processes and subsequent bonding of the module to a PWB are selected based on a strict bonding hierarchy. For example, when a component has been bonded to a substrate by soldering, the solidus temperature of the solder should not be approached during subsequent processing to prevent softening and degradation of the solder connection. A typical solder paste used in the C4 process for bump formation on a wafer is a high-lead-containing material in which the metal component includes 95 wt % lead and 5 wt % tin. The solder bumps resulting from this composition have a liquidus temperature of 315° C. For this solder bump composition, it is essential that the temperature not approach 315° C. during subsequent processing to prevent softening and degradation of the solder connection. For this purpose, eutectic tin/lead0.37 solder paste, having a liquidus temperature of 183° C., is typically used. The bonding hierarchy thus severely limits the types of solder materials that can be used. The temperature at which the material first begins to melt is referred to as the solidus, while the temperature at which the last bit of metal finally dissolves into the liquid phase is called the liquidus.

A further limitation to the choice of useful solder materials is the material of construction of the substrates. For example, lower temperature soldering techniques are required for substrates that are intolerant of high temperatures, for example, polyester. In order to produce reliable interconnects at lower soldering temperatures, the use of lower-melting materials is generally required. For example, a switch from 70Sn/30Pb to 70In/30Pb results in a reduction in melting point temperature from 193° C. to 174° C. Unfortunately, these lower-melting solders often fatigue or deform (e.g., creep) during operation of electronic components, resulting in lowered reliability. As a result, it is often necessary to employ a high-temperature-resistant substrate material, for example, a ceramic. It is therefore desirable to have at one's disposal solder compositions that can make electrical connection at lower temperatures while eliminating or reducing the problems of fatigue and deformation.

Yet a further restriction on the use of solder materials concerns a recent, environmentally-driven lead-free initiative that has increased the need to eliminate lead-containing materials used in solder bumping and metallization in general. Unfortunately, the best alternatives to lead-containing materials have a higher solidus temperature relative to eutectic tin-lead. Presently, Sn/Ag3.0/Cu0.5 solder paste is under consideration as a replacement for eutectic Sn/Pb. Unfortunately, however, the solidus temperature of the Sn/Ag3.0/Cu0.5 alloy is about 217° C., 34° C. higher than that of eutectic Sn/Pb. There is concern that the increased thermal excursion required by this alloy may lead to premature failure of the electronic component. Hence, there remains a need to find a suitable replacement for eutectic Sn/Pb having a relatively low solidus temperature.

Conventional solder pastes used in the formation of interconnect bumps contain metal particles having diameters in the micron range. U.S. Pat. No. 6,630,742 B2, to Sakuyama, discloses a solder powder containing no more than 10 wt % particles whose diameter is greater than the thickness of the mask and no more than 1.5 times this thickness, with a diameter of from 5 to 20 μm being disclosed as exemplary. This purportedly reduces the danger that: the solder paste filling the openings will be wiped away when the mask is coated with the solder paste and a squeegee is moved back and forth over the mask; and the solder paste clinging to the inner walls of the openings of a metal mask will be taken away when the mask is removed. The '742 patent further discloses that if the proportion of solder powder having a particle diameter of 20 μm or less is reduced, problems associated with its preparation, such as labor intensiveness, low yields and high cost, are automatically ameliorated. The '742 patent sets forth as a further advantage for a solder powder having a low proportion of small particle diameter, that the solder paste is less susceptible to oxidation resulting in a longer life for the solder paste.

There is thus a continuing need in the art for methods for the formation of solder areas on an electronic component, for example, interconnect bumps on a semiconductor component for wafer-level-packaging. As well, there is a need in the art for electronic components that can be formed by such methods. The methods and components can prevent or conspicuously ameliorate one or more of the problems mentioned above with respect to the state of the art.

### SUMMARY OF THE INVENTION

In accordance with a first aspect, the present invention provides methods of forming solder areas on an electronic component. The methods involve: (a) providing a substrate having one or more contact pads; and (b) applying a solder paste over the contact pads. The solder paste includes a carrier vehicle and a metal component having metal particles. The solder paste has a solidus temperature lower than the solidus temperature that would result after melting of the solder paste and resolidification of the melt.

In accordance with a further aspect, the present invention provides electronic components. The electronic components include: (a) a substrate having one or more contact pads; and (b) solder paste over the contact pads. The solder paste includes a carrier vehicle and a metal component having metal particles. The solder paste has a solidus temperature lower than the solidus temperature that would result after melting of the solder paste and resolidification of the melt.

Other features and advantages of the present invention will become apparent to one skilled in the art upon review of the following description, claims, and drawings appended hereto.

### BRIEF DESCRIPTION OF THE DRAWINGS

The present invention will be discussed with reference to the following drawings, in which like reference numerals denote like features, and in which:

FIG. 1(a)-(f) illustrates in cross-section solder areas in the form of interconnect bumps on an electronic component at various stages of formation thereof, in accordance with the invention;

FIG. 2(a)-(b) illustrates in cross-section an electronic component formed by bonding an electronic component having solder areas in the form of interconnect bumps to a substrate at various stages of formation thereof, in accordance with a further aspect of the invention;

FIG. 3(a)-(f) illustrates in cross-section solder areas on an electronic component at various stages of formation thereof, in accordance with a further aspect of the invention; and

FIG. 4(a)-(b) illustrates in cross-section bonding of an electronic component having solder areas to a substrate at various stages of formation thereof, in accordance with a further aspect of the invention.

### DETAILED DESCRIPTION OF THE INVENTION

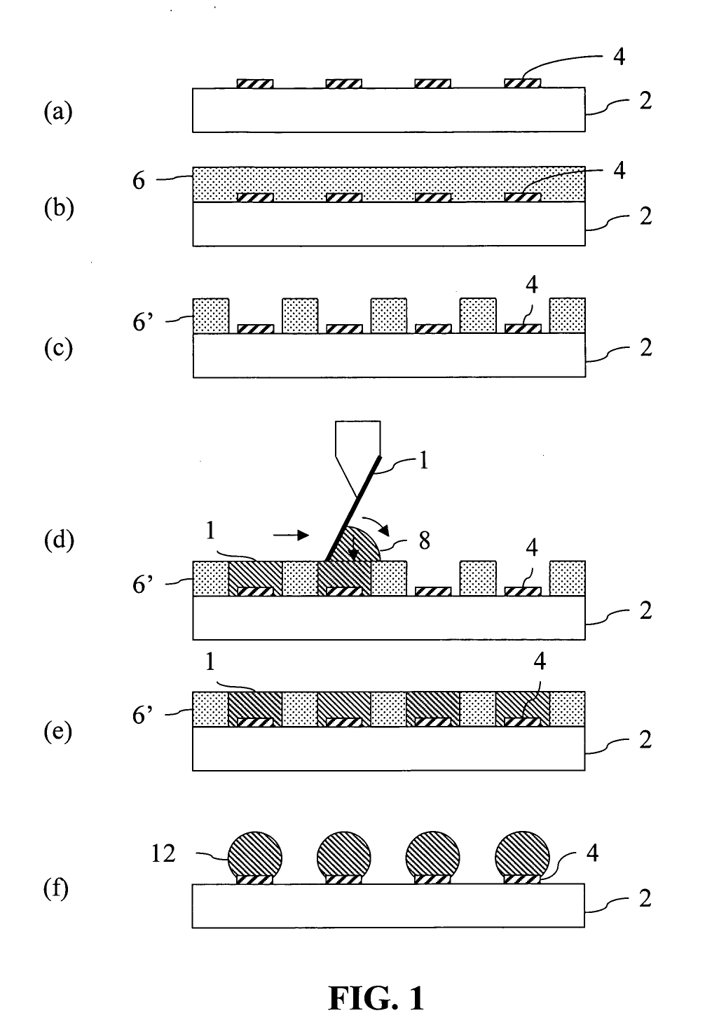

The methods of the invention will now be described with reference to FIG. 1(a)-(f), which illustrates an exemplary process flow of a solder area formation process in accordance with a first aspect of the invention. As used herein, the terms “a” and “an” mean one or more unless otherwise specified. The term nanoparticle means a particle having a diameter of 50 nm or less. The term “metal” means single-component metals, mixtures of metals, metal-alloys, and intermetallic compounds.

The methods of the invention involve forming solder areas on electronic components. The solders used in the present invention are formed from a solder paste containing a metal component in the form of metal particles and a carrier vehicle component. The sizing of the metal particles is chosen such that the solder paste has a solidus temperature lower than the solidus temperature that would result after melting of the solder paste and re-solidification of the melt.

The invention is based on the principle that metal nanoparticles have a lower solidus temperature than their larger-sized counterparts used in conventional solder pastes, which have the same solidus temperature as the bulk metal. The solidus temperature of the metal can be reduced incrementally by incremental reductions in particle size below a threshold value. Once melted and solidified, the resulting metal possesses the solidus temperature of the resolidified melt/bulk material. When incorporated in a solder paste, the nanoparticles are, in the same manner, effective to reduce the solidus temperature of the solder paste in comparison to the subsequently melted and solidified material. As a result, it is possible to form solder areas at a given temperature which do not reflow during subsequent heat treatment processes at that same (or even higher) temperatures. This allows for significant flexibility in bonding hierarchy of an electronic component, as well as in the choice of solder paste and other device materials.

Further, the metal particles used may result in the reduction or elimination of organic residues that may remain after reflow of the solder paste when organic components are used, for example, in a fluxing agent. While not wishing to be bound by any particular theory, it is believed that the relatively high surface area of the metal particles in the solder paste may increase the catalytic rate of decomposition of the organic materials.

While the effective size of the metal particles will depend, for example, on the particular metal and the desired solidus temperature of the solder paste, useful particles are generally in the nanometer-size range. Nanoparticles can be produced by a variety of known techniques, for example, chemical vapor deposition (CVD), physical vapor deposition (PVD) such as sputtering, electrolytic deposition, laser decomposition, arc heating, high-temperature flame or plasma spray, aerosol combustion, electrostatic spraying, templated electrodeposition, precipitation, condensation, grinding, and the like. International publication No. WO 96/06700, for example, the entire contents of which are incorporated herein by reference, discloses techniques for forming nanoparticles from a starting material by heating and decomposition of a starting material using an energy source, such as a laser, electric arc, flame, or plasma.

The metal particles useful in the present invention include, for example, tin (Sn), lead (Pb), silver (Ag), bismuth (Bi), indium (In), antimony (Sb), gold (Au), nickel (Ni), copper (Cu), aluminum (Al), palladium (Pd), platinum (Pt), zinc (Zn), germanium (Ge), lanthanides, combinations thereof, and alloys thereof. Of these, Sn, Pb, Ag, Bi, In, Au, Cu, combinations thereof, and alloys thereof, are typical, for example, tin and tin-alloys, such as Sn—Pb, Sn—Ag, Sn—Cu, Sn—Ag—Cu, Sn—Bi, Sn—Ag—Bi, Sn—Au, and Sn—In. More particularly, Sn—Pb37, Sn—Pb95, Sn—Ag3.5, Sn/Ag3.0/Cu0.5 (wt % based on the metal component), and the like find use in the invention.

The metal particle size and size distribution in the solder paste can be selected to provide a desired solidus temperature, which will depend, for example, on the type(s) of particles. For example, the particle size and distribution can be selected to provide a solidus temperature for the solder paste that is 3 or more C.° lower, for example, 5 or more C.° lower, 10 or more C.° lower, 50 or more C.° lower, 100 or more C.° lower, 200 or more C.° lower, 400 or more C.° lower, or 500 or more C.° lower than the resulting solidus temperature would be after melting of the solder paste and resolidification of the melt.

The metal particles are typically present in the solder paste in an amount greater than 50 wt %, for example, greater than 85 wt %, based on the solder paste. As set forth above, the particle size effective to lower the solidus temperature of the metal particles and resulting solder paste will depend on the particular type(s) of particle material. Generally, it will be sufficient if 50% or more of the particles, for example, 75% or more, 90% or more, or 99% or more, have a diameter of 50 nm or less, for example, 30 nm or less, 20 nm or less, or 10 nm or less. Generally, the average diameter of the metal and/or metal-alloy particles is 50 nm or less, for example, 30 nm or less, 20 nm or less, or 10 nm or less. Typically, the size and size distribution of the metal particles is effective to allow melting of the solder paste at a lower temperature than the solidus temperature of the solidified melt. However, it may be sufficient if a percentage of the particles are of a larger size that do not melt, assuming the resulting solder area provides a sufficiently reliable electrical connection in the electronic component. A portion of the larger particles may dissolve into the melted portion of the solder paste.

The carrier vehicle can contain one or more components, for example, one or more of a solvent, a fluxing agent, and an activator. The carrier vehicle is typically present in the solder paste in an amount of from 1 to 20 wt %, for example, from 5 to 15 wt %.

A solvent is typically present in the carrier vehicle to adjust the viscosity of the solder paste, which is typically from 100 kcps (kilocentipoise) to 2,000 kcps, for example, from 500 to 1,500 kcps or from 750 to 1,000 kcps. Suitable solvents include, for example, organic solvents, such as low molecular weight alcohols, such as ethanol, ketones, such as methyl ethyl ketone, esters, such as ethyl acetate, and hydrocarbons, such as kerosene. The solvent is typically present in the carrier vehicle in an amount of from 10 to 50 wt %, for example, from 30 to 40 wt %.

A fluxing agent can further be included in the carrier vehicle to enhance adhesion of the solder paste to the substrate. Suitable fluxing agents include, for example, one or more rosins such as polymerized rosins, hydrogenated rosins, and esterified rosins, fatty acids, glycerine, or soft waxes. When used, the fluxing agent is typically present in the carrier vehicle in an amount of from 25 to 80 wt %.

Activators help to remove oxide formed on the surface of the contact pads or on the surface of the metal particles when the solder paste is heated. Suitable activators are known in the art, and include, for example, one or more organic acid, such as succinic acid or adipic acid and/or organic amine, such as urea, other metallic chelators, such as EDTA, halide compounds, such as ammonium chloride or hydrochloric acid. When used, the activator is typically present in the carrier vehicle in an amount of from 0.5 to 10 wt %, for example, from 1 to 5 wt %.

Additional additives may optionally be used in the solder paste, for example, thixotropic agents, such as hardened castor oil, hydroxystearic acid, or polyhydridic alcohols. The optional additives are typically present in the solder paste in an amount of from 0 to 5 wt %, for example, from 0.5 to 2.0 wt %.

To reduce the possibility of corrosion of the formed electronic components and the associated problems, the solder paste may be substantially free of halogen and alkali metal atoms. Typically, the halogen and alkali metal atom content in the solder is less than 100 ppm, for example, less than 1 ppm.

The solder pastes in accordance with the invention can be formed by blending the metal component with the carrier vehicle components, including any desired optional components. The non-metal components may be blended first to provide a more uniform dispersion.

FIG. 1(a)-(f) illustrates in cross-section solder areas in the form of interconnect bumps on an electronic component at various stages of formation thereof, in accordance with one aspect of the invention. With reference to FIG. 1(a), a substrate 2 of an electronic component is provided. The electronic component can be, for example, a semiconductor wafer, such as a single-crystal silicon wafer, a silicon-on-sapphire (SOS) substrate, or a silicon-on-insulator (SOI) substrate, a singulated semiconductor chip such as an IC chip, a module circuit which may hold one or more semiconductor chips, a printed wiring board, or a combination thereof.

The substrate has one or more contact pad 4, typically a plurality of contact pads 4, on a surface thereof. The contact pads 4 are formed of one or more layer of a metal, composite metal or metal alloy typically formed by physical vapor deposition (PVD) such as sputtering or evaporation or plating. Typical contact pad materials include, without limitation, aluminum, copper, titanium nitride, chrome, tin, nickel, and combinations and alloys thereof. A passivation layer is typically formed over the contact pads 4, and openings extending to the contact pads are formed therein by an etching process, typically by dry etching. The passivation layer is typically an insulating material, for example, silicon nitride, silicon oxynitride, or a silicon oxide, such as phosphosilicate glass (PSG). Such materials can be deposited by chemical vapor deposition (CVD) processes, such as plasma enhanced CVD (PECVD). The contact pads 4 act as an adhesive layer and electrical contact base for the solder area to be formed. The contact pads are typically square or rectangular in shape, although other shapes may be used.

A patterned mask having openings corresponding to the contact pads is brought into proximity with the substrate surface or can be formed on the surface of the substrate, as is known in the art. The patterned mask can be, for example, a metal plate (not shown) having openings formed therethrough corresponding to the contact pads, and is placed in contact or near contact with the substrate surface in alignment. Alternatively, the mask can be formed on the substrate surface as shown in FIGS. 1(b) and (c). In this case, a mask material 6 such as a photoresist material, for example, Shipley BPR™ 100 resist, commercially available from Shipley Company, L.L.C., Marlborough, Mass., can be coated on the surface of the substrate 2. The photoresist layer 6 is patterned by standard photolithographic exposure and development techniques to form mask 6′. A mask can alternatively be formed on the substrate surface, for example, by coating and etching a dielectric layer, such as a silicon oxide, silicon nitride, or silicon oxynitride.

The mask openings typically extend beyond the periphery of the contact pads 4 to allow coating of the solder over the pads and peripheral areas beyond the pads. The mask openings can be of various geometries, but typically are of the same shape as the contact pads 4. Without limitation, the mask 6′ thickness should be sufficiently thick to allow coating of the solder paste to a desired thickness.

A solder paste 8 as described above is next coated over the contact pads 2. While the thickness will depend on the particular solder paste and geometries involved, the solder paste is typically coated over the contact pads 4 to a thickness of, for example, from 50 to 150 μm in thickness or from 200 to 400 μm in thickness. As shown in FIG. 1(d), this can be accomplished, for example, by depositing the solder paste on the surface of the mask 6′, and moving the solder paste across the surface of the mask using a tool such as a squeegee 10. In this way, the solder paste is moved into the holes of the mask over the contact pads shown as solder paste areas 12 in FIGS. 1(d) and (e). The mask 6′ is typically, but not necessarily, removed and the substrate 2 is heated to melt the solder paste, thus forming solder bumps 12′, as shown in FIG. 1(f). The heating can be conducted in a reflow oven at a temperature at which the solder paste melts and flows into a truncated substantially spherical shape, thus forming solder bumps 12′ as shown in FIG. 1(f). Suitable heating techniques are known in the art, and include, for example, infrared, conduction, and convection techniques, and combinations thereof. The reflowed interconnect bump is generally coextensive with the edges of the contact pad structure. The heat treatment step can be conducted in an inert gas atmosphere or in air, with the particular process temperature and time being dependent upon the particular composition of the solder paste and size of the metal particles therein.

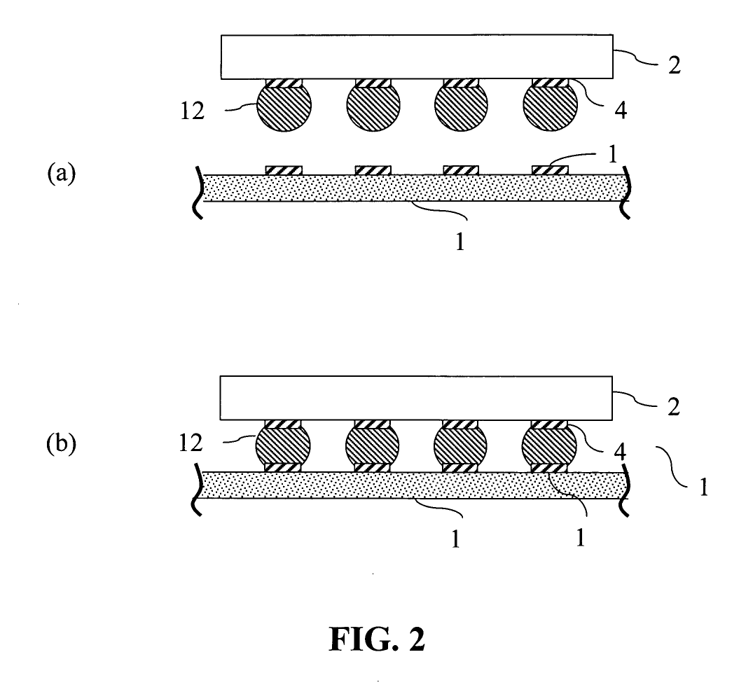

FIG. 2(a)-(b) illustrates in cross-section an electronic component 13 formed by bonding an electronic component, as described above having solder areas in the form of interconnect bumps 12′, to a substrate 14 having contact pads 16 corresponding to the solder bumps 12′. This bonding technique is useful for bonding two electronic components together, for example, an IC to a device package, a module circuit or a PWB directly, or a module circuit or device package to a PWB. The contact pads 16 of the component 14 may be constructed from a material as described above with reference to the contact pads 4. Contact pads 16 are commonly Al, Cu, Ni, Pd, or Au. With reference to FIG. 2(a), the two electronic components are brought into general alignment and contact with each other such that the solder areas 12′ of one electronic component are in general alignment and contact with the contact pads 16 of the component 14. Next, the components are heated to a temperature effective to melt the solder bumps 12′, thus forming a bond with contact pads 16. The heating can be conducted using the same techniques described above with respect to the heating of the solder paste used in forming solder bumps 12′.

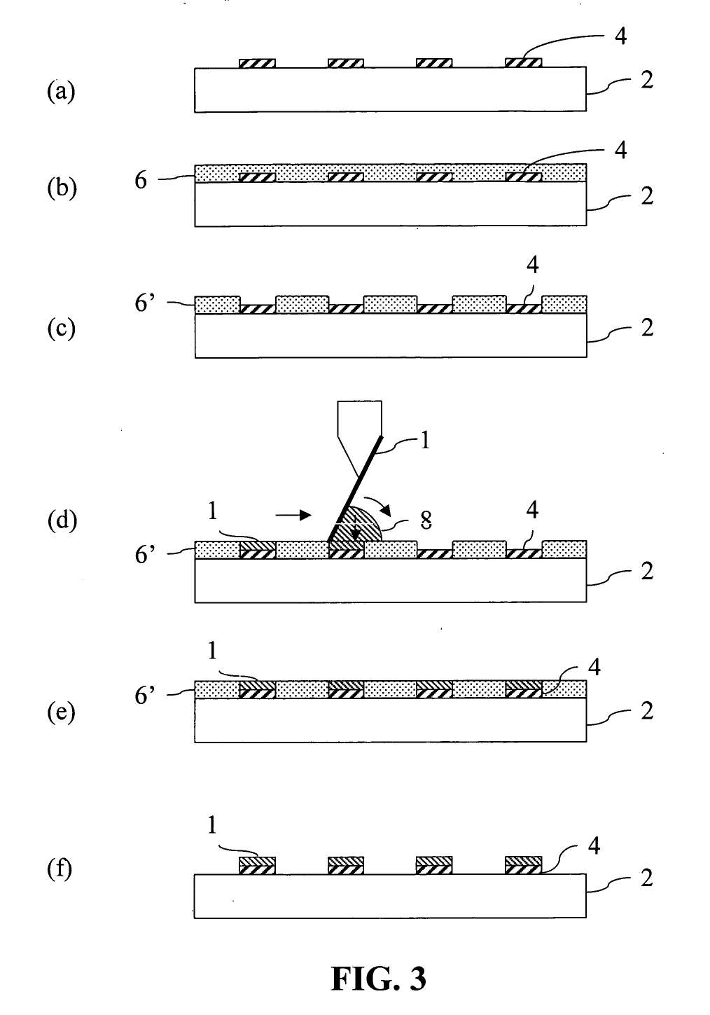

FIG. 3(a)-(f) illustrates in cross-section solder areas on an electronic component at various stages of formation thereof, in accordance with a further aspect of the invention. This aspect of the invention is useful, for example, in bonding two electronic components together wherein the two components are brought into contact with each other prior to melting the nanoparticle solder paste. The description above with respect to FIG. 1(a)-(e) is generally applicable to FIG. 3(a)-(e). It may be beneficial in this aspect of the invention to employ a solder paste thickness less than that used in the formation of solder bumps. For example, the solder paste may be coated over the contact pads 4 to a thickness of, for example, from 1 to 50 μm in thickness or from 10 to 20 μm in thickness. In addition, it may be desirable to limit the solder areas to the contact pads as shown. The mask 6′ is next removed, as shown in FIG. 3(f), thus forming an electronic component having solder areas 12 in the form of nanoparticle solder paste formed over the contact pads 4.

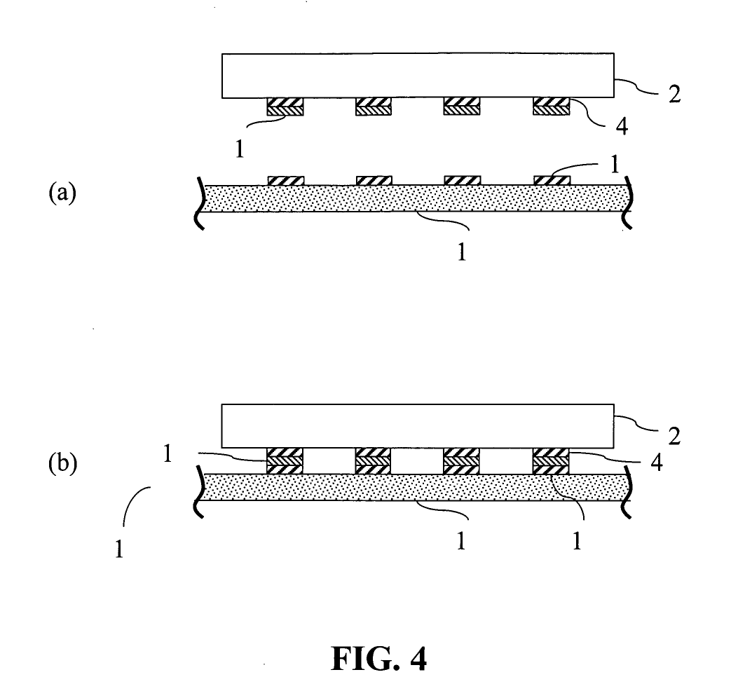

FIG. 4(a)-(b) illustrates in cross-section an electronic component 13 formed by bonding an electronic component, as described above having solder areas in the form of nanoparticle solder paste 12, to a substrate 14 having contact pads 16 corresponding to the solder bumps 12. The description above with respect to FIG. 2(a)-(b) is generally applicable unless otherwise noted. The contact pads 16 of the component 14 in this embodiment may be constructed from a material as described above with reference to the contact pads 4, typically Al, Cu, Ni, Pd, or Au. With reference to FIG. 4(a), the two electronic components are brought into general alignment and contact with each other such that the solder areas 12 of one electronic component are in general alignment and contact with the contact pads 16 of the component 14. Next, the components are heated to a temperature effective to melt the solder paste 12. Upon solidification of the melt, a bond is formed between the two components having a higher solidus temperature than the starting solder paste. The heating can be conducted using the same techniques described above with reference to FIG. 1 regarding the heating of the solder paste used in forming solder bumps. It should be clear that the solder paste areas can be formed on the contact pads of either or both substrates before bringing the substrates into contact.

The following prophetic examples are intended to further illustrate the present invention, but are not intended to limit the scope of the invention in any aspect.

### EXAMPLES 1-10

Nanoparticle solder pastes in accordance with the invention are prepared as follows. A 0.25M benzoic acid solution is prepared from 0.92 g of benzoic acid and 20 ml diethyl ether. 86 g of solder alloy nanoparticles are added to the solution and soaked for an hour with occasional stirring. The powder slurry is rinsed and dried. A rosin-based flux is prepared from 50 wt % rosin, 41 wt % glycol solvent, 4 wt % succinic acid, and 5 wt % castor oil. The flux is added to the metal particles to form a paste with 88 wt % metal by weight, as described in Table 1. The resulting solder pastes are used to form solder areas on electronic devices as described below.

Semiconductor wafers having IC chips formed on the surface thereof are provided. Each IC chip has 64 contact pads (200 μm on each side) at a pitch of 100 μm. A metal mask is placed in contact with the surface, the mask having openings with a diameter of 150 μm exposing the contact pads . Solder paste is spread across the mask with a squeegee, the solder paste filling the openings in the mask. The wafer is heated to the expected solidus temperature (Tₛₒₗ) shown in Table 1, thus melting the solder and forming solder areas in the form of solder bumps on the contact pads. The difference between Tₛₒₗ and expected solidus temperature of the solder paste after melting and solidification thereof (Tₛₒₗ−T_{bulk}) is also shown in Table 1. As can be seen, significant decreases in the expected solidus temperature can be achieved for a given material by use of nanoparticle solder pastes. Further, the extent of this decrease can be controlled by tuning of the metal particle size.

TABLE 1

| | Metal Component | | | |
|---|---|---|---|---|
| Example | Material | Part. Size (nm) | Tₛₒₗ(° C.) | Tₛₒₗ₋T_{bulk}(° C.) |
| 1 | Au | 5 nm | 827 | −100 |
| 2 | Au | 3 nm | 627 | −300 |
| 3 | Au | 2 nm | 152 | −639 |
| 4 | Sn | 20 nm | 227 | −5 |
| 5 | Sn | 5 nm | 207 | −25 |
| 6 | Al | 2 nm | 527 | −140 |
| 7 | In | 15 nm | 144 | −13 |
| 8 | Pb | 15 nm | 317 | −10 |
| 9 | 63Sn/37Pb | 10 nm | 170 | −13 |
| 10 | 80Au/20Sn | 15 nm | 270 | −10 |
| 11 | 80Au/20Sn | 5 nm | 200 | −80 |

While the invention has been described in detail with reference to specific embodiments thereof, it will be apparent to one skilled in the art that various changes and modifications can be made, and equivalents employed, without departing from the scope of the claims.

1. A method of forming solder areas on an electronic component, comprising:
(a) providing a substrate comprising one or more contact pads; and
(b) applying a solder paste over the contact pads, the solder paste comprising
a carrier vehicle and a metal component comprising metal particles,
wherein the solder paste has a solidus temperature lower than the solidus temperature that would result after melting of the solder paste and re-solidification of the melt.

2. The method of claim 1, wherein 50% or more of the particles have a diameter of 50 nm or less.

3. The method of claim 1, wherein the average diameter of the metal and/or metal-alloy particles is 30 nm or less.

4. The method of claim 1, wherein the metal particles comprise particles chosen from Sn, Pb, Ag, Bi, In, Au, Cu, Zn, Sb, Ge, lanthanide elements, combinations thereof, and alloys thereof.

5. The method of claim 1, wherein the solidus temperature of the solder paste is 3 or more C.° lower than the solidus temperature that would result after melting of the solder paste and re-solidification of the melt.

6. The method of claim 1, further comprising:
(c) heating the solder paste at a temperature effective to melt the solder paste; and
(d) solidifying the melt.

7. The method of claim 6, wherein the substrate comprises a plurality of contact pads and a plurality of corresponding solder areas over the contact pads.

8. The method of claim 6, further comprising:
(e) providing a second substrate comprising one or more contact pads corresponding to the one or more contact pads of the first substrate;
(f) after (d), bringing the first and second substrates into contact with each other, wherein the second substrate contact pads are in alignment with the contact pads of the first substrate; and
(g) heating the first and second substrates, thereby bonding the first substrate to the second substrate.

9. The method of claim 1, wherein the electronic component is a semiconductor wafer, a singulated semiconductor chip, a module circuit, an optoelectronic component, a printed wiring board, or a combination thereof.

10. The method of claim 1, further comprising:
(c) providing a second substrate comprising one or more contact pads corresponding to the one or more contact pads of the first substrate; and
(d) bringing the first and second substrates into contact with each other, wherein the second substrate contact pads are in alignment with the contact pads of the first substrate.

11. The method of claim 10, wherein in (d) the second substrate contact pads are in contact with the solder paste, and further comprising:
(e) after (d), heating the solder paste at a temperature effective to melt the solder paste.

12. The method of claim 11, wherein the first substrate and the second substrate are each chosen from a semiconductor wafer, a singulated semiconductor chip, a module circuit, an optoelectronic component, a printed wiring board, or a combination thereof.

13. An electronic component, comprising:
(a) a substrate comprising one or more contact pads; and
(b) solder paste over the contact pads, the solder paste comprising a carrier vehicle and a metal component comprising metal particles,
wherein the solder paste has a solidus temperature lower than the solidus temperature that would result after melting of the solder paste and resolidification of the melt.

14. The electronic component of claim 13, wherein 50% or more of the particles have a diameter of 50 nm or less.

15. The electronic component of claim 13, wherein the average diameter of the metal and/or metal-alloy particles is 30 nm or less.

16. The electronic component of claim 13, wherein the metal particles comprise particles chosen from Sn, Pb, Ag, Bi, In, Au, Cu, Zn, Sb, Ge, lanthanide elements, combinations thereof, and alloys thereof.

17. The electronic component of claim 13, wherein the solidus temperature of the solder paste is 3 or more C.° lower than the solidus temperature that would result after melting of the solder paste and resolidification of the melt.

18. The electronic component of claim 13, wherein the substrate comprises a plurality of contact pads and corresponding solder bumps over the contact pads.

19. The electronic component of claim 13, further comprising a second substrate in contact with the first substrate, the second substrate comprising one or more contact pads corresponding to the one or more contact pads of the first substrate.

20. The electronic component of claim 13, wherein the electronic component is a semiconductor wafer, a singulated semiconductor chip, a module circuit, an optoelectronic component, a printed wiring board, or a combination thereof.
